(19) United States
(12) Patent Application Publication
(10) Pub. No.: US 2022/0261429 A1
(43) Pub. Date: Aug. 18, 2022

(54) SYSTEM AND METHOD FOR IMPROVED SIMILARITY SEARCH FOR SEARCH ENGINES

(71) Applicant: GSI Technology Inc., Sunnyvale, CA (US)

(72) Inventors: Tal REFAELI, Ramat Gan (IL); Yoav Asher WECHSLER, Karnei Shomron (IL)

(21) Appl. No.: 17/574,597

(22) Filed: Jan. 13, 2022

Related U.S. Application Data
(60) Provisional application No. 63/150,122, filed on Feb. 17, 2021.
(60) Provisional application No. 63/298,226, filed on Jan. 11, 2022.

(51) Int. Cl. G06F 16/33; G06F 16/245; G06F 16/2453; G06F 11/34

(52) U.S. Cl. CPC G06F 16/3347; G06F 11/3419; G06F 16/24532; G06F 16/24569

(57) ABSTRACT

A system and method for an improved similarity search for an Elasticsearch engine includes an accelerated processing unit (APU) to process a vector query for a similarity search using cosine similarity; and a plugin to said Elasticsearch engine to identify a vector query uploaded to the Elasticsearch engine by a user, to divert the vector query to the APU for processing and to return a set of results to the user for the similarity search, each result having an index and ordinal scale representing its distance from the vector query.

### CROSS REFERENCE TO RELATED APPLICATIONS

This application claims priority from U.S. Provisional Patent Application No. 63/150,122, filed Feb. 17, 2021, and from U.S. Provisional Patent Application No. 63/298,226 filed Jan. 11, 2022, both of which are incorporated herein by reference.

### FIELD OF THE INVENTION

The present invention relates to internet searches generally and to similarity searches in particular.

### BACKGROUND OF THE INVENTION

Web searches have become essential for surfing the Internet with a variety of search engines available for use ranging from Google (commercially available from Google LLC) to Yahoo (commercially available from Yahoo Inc.) and many more.

Another search engine is Elasticsearch (commercially available from Elastic NV), a highly scalable open-source full-text search and analytic engine which allows its user to store, search and analyze big volumes of data quickly and in near real time. It is built on the Lucene library (commercially available from Apache Software Foundation) and provides a distributed system for indexing and automatic type guessing. General data is uploaded in a document format including text and meta data to describe it, for example meta data describing a category such as nature or health. The data is indexed accordingly and its associated database is continually updated. Elasticsearch indexes, searches and aggregates data and supports text, keyword, numeric, range, geo points and shapes and floating point dense vector searches.

A user may submit a query to Elasticsearch. The submitted query is typically a free-text query also in document format. Each query can have a header, text and metadata on which to search on. Elasticsearch also allows for a filter with the query such as “search for an abstract to do with plants in the category health and not nature”. Typical uses for Elasticsearch are questions and answers, article searches and image searches.

Elasticsearch receives the words and sentences of the documents and queries as numeric vectors (after inference) which capture the linguistic content of the text and which can be used to assess the similarity between a query and a data document. The data documents are then ranked according to their closeness to the submitted query and a text result is produced.

Elasticsearch searches are typically run on cloud providers such as AWS (Amazon Web Servers commercially available from Amazon.com). Elasticsearch also freely allows plugins to work with it to enhance its functionality in a customized manner.

U.S. Pat. No. 10,929,751 entitled “FINDING K EXTREME VALUES IN CONSTANT PROCESSING TIME”, issued 23 Feb. 2021 commonly owned by Applicant and incorporated herein by reference, describes a system and method for associated memory processing for large datasets.

### SUMMARY OF THE PRESENT INVENTION

There is provided, in accordance with a preferred embodiment of the present invention, a system for an improved similarity search for an Elasticsearch engine. The system includes an accelerated processing unit (APU) to process a vector query for a similarity search using cosine similarity; and a plugin to the Elasticsearch engine to identify a vector query uploaded to the Elastic search engine by a user, to divert the vector query to the APU for processing and to return a set of results to the user for the similarity search, each result having an index and ordinal scale representing its distance from the vector query.

Moreover, in accordance with a preferred embodiment of the present invention, the plugin includes a query receiver and identifier to receive the vector query and to determine if it is to be diverted to the APU, a load service to load at least one dataset to the APU for the vector query, a pre-search filterer to search the at least one dataset for meta data that match the vector query and to filter out non matched data vectors, a query diverter to divert matched data vectors to the APU and a result handler to return the set of results to the user.

Moreover, in accordance with a preferred embodiment of the present invention, the system further includes a batch processor to simultaneously process multiple vector queries.

Further, in accordance with a preferred embodiment of the present invention, the plugin retrieves a vector query as at least one of: a FP32 format and an Int2vector.

Still further, in accordance with a preferred embodiment of the present invention, the query receiver and identifier utilizes Hamming Search and Cosine Re-rank algorithms.

Additionally, in accordance with a preferred embodiment of the present invention, the at least one dataset is loaded by an external user web application to the system.

There is provided, in accordance with a preferred embodiment of the present invention, a method for an improved similarity search for an Elastic search engine. The method includes processing using an accelerated processing unit (APU) a vector query for a similarity search using cosine similarity, identifying a vector query uploaded to the Elasticsearch engine by a user, diverting the vector query to the APU for processing and returning a set of results to the user for the similarity search, each result having an index and ordinal scale representing its distance from the vector query.

Moreover, in accordance with a preferred embodiment of the present invention, the identifying, diverting and returning includes receiving the vector query and determining if it is to be diverted to the APU; loading at least one dataset to the APU for the vector query; searching the at least one dataset for meta data that match the vector query and filtering out non matched data vectors, diverting matched data vectors to the APU and returning the set of results to the user.

Moreover, in accordance with a preferred embodiment of the present invention, the method includes simultaneously processing multiple vector queries.

Further, in accordance with a preferred embodiment of the present invention, the identifying retrieves a vector query as at least one of: a FP32 format and an Int2vector.

Still further, in accordance with a preferred embodiment of the present invention, the determining if it is to be diverted utilizes Hamming Search and Cosine Re-rank algorithms.

Additionally, in accordance with a preferred embodiment of the present invention, the at least one dataset is loaded by an external user web application.

There is provided, in accordance with a preferred embodiment of the present invention, a plugin for an Elastic search engine. The plugin includes a query receiver and identifier to identify a vector query for a similarity search uploaded by a user and to determine that it is to be diverted to a dedicated accelerated processing unit (APU); a load service to load at least one dataset to the APU for the vector query; a pre-search filterer to search the at least one dataset for meta data that matches the vector query and to filter out non matched data vectors; a query diverter to divert matched data vectors to the APU and a result handler to return a set of results to the user for the similarity search, each result having an index and ordinal scale representing its distance from the vector query.

Moreover, in accordance with a preferred embodiment of the present invention, the plugin includes a batch processor to simultaneously process multiple vector queries.

Further, in accordance with a preferred embodiment of the present invention, the plugin retrieves a vector query as at least one of: a FP32 format and an Int2vector.

Still further, in accordance with a preferred embodiment of the present invention, the query receiver and identifier utilizes Hamming Search and Cosine Re-rank algorithms.

Additionally, in accordance with a preferred embodiment of the present invention, the at least one dataset is loaded by an external user web application.

There is provided, in accordance with a preferred embodiment of the present invention, a method for an Elasticsearch engine. The method includes identifying a vector query for a similarity search uploaded by a user and determining that it is to be diverted to a dedicated accelerated processing unit (APU), loading at least one dataset to the APU for the vector query, searching the at least one dataset for meta data that matches the vector query and filtering out non matched data vectors; diverting matched data vectors to the APU; and returning a set of results to the user for the similarity search, each result having an index and ordinal scale representing its distance from the vector query.

Moreover, in accordance with a preferred embodiment of the present invention, the method includes simultaneously processing multiple vector queries.

Further, in accordance with a preferred embodiment of the present invention, the identifying retrieves a vector query as at least one of: a FP32 format and an Int2vector.

Still further, in accordance with a preferred embodiment of the present invention, the identifying and the determining utilize Hamming Search and Cosine Re-rank algorithms.

Additionally, in accordance with a preferred embodiment of the present invention, the at least one dataset is loaded by an external user web application.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a user sending a query to Elasticsearch which is further diverted to a dedicated APU, constructed and operative in accordance with the present invention;

FIG. 2 is a schematic illustration of a system for diverting Elasticsearch queries, constructed and operative in accordance with the present invention;

FIG. 3 is a schematic illustration of the inputs and outputs to the system of FIG. 2 constructed and operative in accordance with the present invention;

FIG. 4 is a schematic illustration of the elements of the plugin of FIG. 2 constructed and operative in accordance with the present invention;

FIG. 5 is a schematic illustration of tabulated benchmark data for different searches using the system of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that due to the high requirement for processing power which can be costly and time consuming (often processing in parallel), the Elasticsearch similarity search when run on cloud providers (such as AWS as described in the background) is typically limited (and in particular for vector queries) to small datasets. The search cannot perform efficiently on large datasets due to the complicated calculations required and the resources drained.

Applicant has further realized that a plugin to the Elasticsearch that deploys a search query to a massively parallel processing environment may allow for a more efficient and faster search in particular for large sizes of dense vector datasets and batches of queries. The deploying or diverting of searches to a more efficient hardware infrastructure may also save on processing time and money providing a lower cost per query service.

The plugin used may be installed as a plugin zip file as a standard Elasticsearch plugin installation, may identify feature vector searches and may ignore other search types (such as meta data).

Applicant has further realized that a viable parallel processing environment is an associative processing unit (APU) such as Gemini (commercially available from GSI technology Inc.) and that a plugin that diverts to the APU may produce a response 100 times faster than a standard Elasticsearch similarity search. The Gemini APU utilizes an associated memory array as described in U.S. Pat. No. 10,929,751 that ensures that activity is minimal by relieving the need for read/write functionality. All functionality is performed in the memory array.

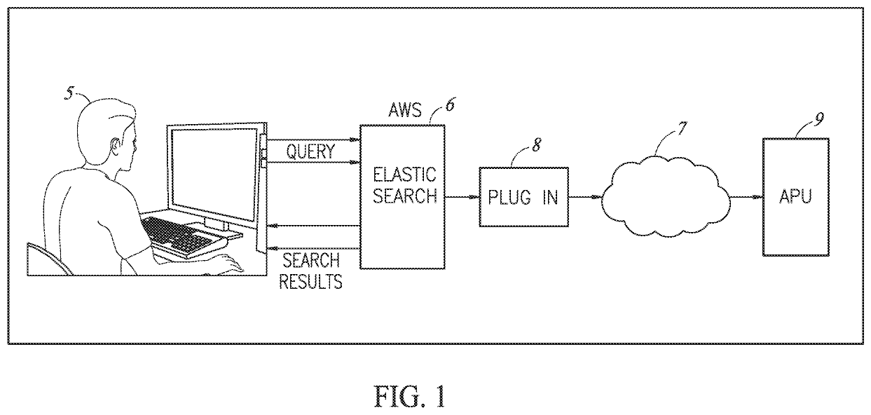

Reference is now made to FIG. 1 which shows a user 5 sending a query to Elasticsearch sitting 6 and how the query is diverted to APU 9 sitting via plugin 8 and cloud 7.

It will be appreciated that the dataset required for the APU database may come from a separate load service via a load data request. The dataset upload may be performed offline in parallel as a pure Elasticsearch document. Data may also be uploaded by an external user web application. Multiple databases may also be loaded onto the APU and each query may identify the database to be searched. As discussed herein above, the loaded datasets for the APU must be in vector format.

It will also be appreciated that the plugin may allow for multiple queries. These may be multiple queries within the same query document.

Once a query has been diverted and processed by the APU, the top results together with scores are sent back to the user via the pertinent working cloud.

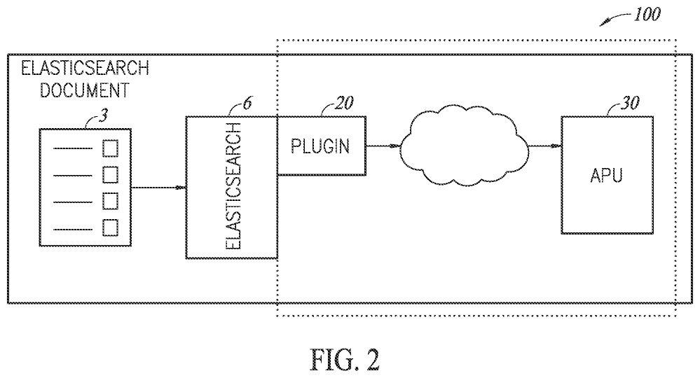

Reference is now made to FIG. 2 which illustrates a system 100 for diverting and resolving vector queries for an Elasticsearch query according to an embodiment of the present invention. System 100 may further comprise a plugin 20 and an APU 30. As described hereinabove, plugin 20 may divert an Elasticsearch vector query as defined in Elasticsearch document 3 from Elasticsearch 6 and divert it to APU 30 for processing.

It will be appreciated that plugin 20 may be packaged as an archive (zip) file containing a properties file having metadata (name version, description etc.) and compiled Java classes with the plugin code. Plugin 20 may also comprise a tool for enabling its own installation and removal. It will further be appreciated that plugin 20 may retrieve the vectors (both data to be searched and query) as FP32 format or Int2vectors.

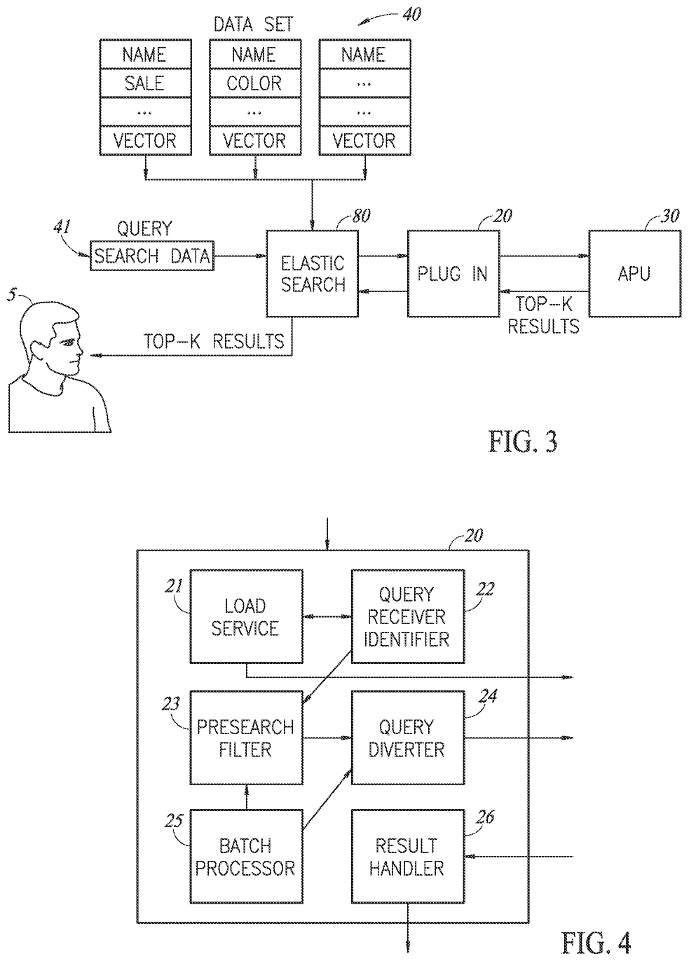

Reference is now made to FIG. 3 which illustrates the various inputs and outputs involved for system 100. User 5 may upload a query to the Elasticsearch system 80 as search data 41 which may, as part of its metadata in its header, define which search system it wishes to search (such as APU 30) and which dataset to use. It will be appreciated that dataset 40 (as a vector dataset) may constantly be updated and uploaded to APU using plugin 20 from Elasticsearch 80. Plugin 20 may identify all uploaded queries to Elasticsearch 80 and identify and divert designated vector queries to APU 30. It will also be appreciated that plugin 20 may also perform a pre-search filter to filter out irrelevant vectors from the loaded datasets to be searched as described in more detail herein below. APU 30 may then process the query and return search results (top-k, indices and distance) as described in more detail herein below.

Reference is now made to FIG. 4 which shows the elements which provide the processes involved for plugin 20. Plugin 20 may comprise a load service 21 to load to APU 30 the dataset, a query receiver and identifier 22 to receive a query with search data 41 and to identify vector queries that include an indicator in the header that the user wishes to have his query diverted to APU 30, a pre-search falterer 23 to filter out unsuitable queries, a query diverter 24 to divert suitable queries, a batch processor 25 to simultaneously process multiple queries and a result handler 26 to receive results from APU 30 to be returned to the user. The functionality of these elements is described in more detail herein below.

It will be appreciated that the dataset required for the search may come from a separate load service via a load data request. The dataset upload may also be performed offline in parallel to the search as an Elasticsearch document. Datasets may also be loaded by an external user web application. Multiple datasets or databases may also be uploaded to APU 30 via load service 21 and each query may identify the database to search. It will also be appreciated that APU 30 may continually update its search data via load service 21.

Query receiver and identifier 22 may use Hamming Search and Cosine Re-rank algorithms to identify and retrieve suitable vector queries that have an indication in the query header as slated for diversion to APU 30.

Pre-search filterer 23 may search the loaded datasets for vectors containing meta data that match the query and filter accordingly. For example, for a query that searches for “yellow Subaru car”, pre-search filterer 23 may mark only the dataset vectors that have meta data that matches “yellow”, “Subaru” and “car”.

Query diverter 24 may then forward the relevant dataset index to APU 30 to run a search on the pertinent dataset indexes only. As discussed herein above, system 100 may run the query search only on the dataset that includes the metadata filters and may return the TOP-K query results only to dataset vectors that match the filter.

Batch processor 25 may aggregate multiple queries and forward them via query diverter 24 to APU 30 as a single batch to be run in parallel.

As discussed herein above, APU 30 may perform massive parallel data processing (computations and searches) directly within the memory array. This is far more efficient than the serial data processing of Elasticsearch where data is moved back and forth between the processor and the memory. APU 30 may allow high performance K and Approximate Nearest Neighbor (KNN and ANN) implementations and scaling similarity searches. The KNN classification of a query is performed by calculating the cosine similarity between the query and the items in the database and by classifying the results in a class of the K nearest neighbors. The resulting output returned to user 5 is the top-K results. It will be appreciated that each result may have an index and an ordinal scale representing its distance from the query.

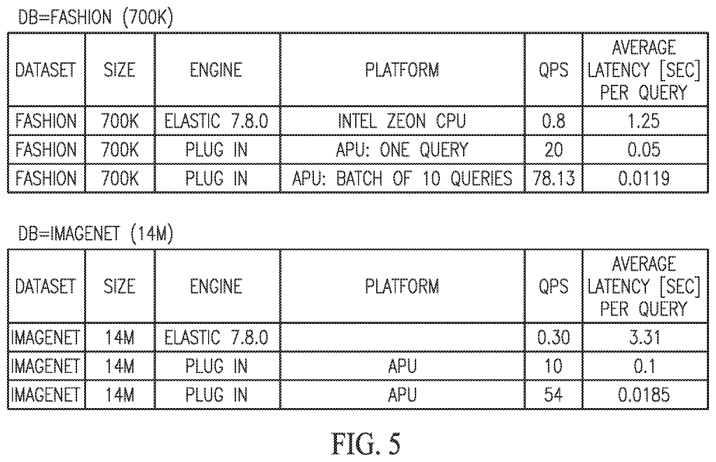

Reference is now made to FIG. 5 which illustrates benchmark data for different searches. As can be seen, the average latency per query is far faster using plugin 20. As is shown, for a fashion query (which could be a search for a particular dress), using Elasticsearch the average latency is 1.25 seconds. A single query using plugin 20 may take 0.05 seconds and a batch query may even take 0.0119 seconds since it is run in parallel.

Thus two separate systems (Elasticsearch and APU 30) may work together (via plugin 20) as a single unit typically functioning on the same server. The connections are seamless and by diverting a query to APU 30, a user may receive a fast response, typically 100 times faster than a regular Elasticsearch result.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for an improved similarity search for an Elasticsearch engine, the system comprising:
an accelerated processing unit (APU) to process a vector query for a similarity search using cosine similarity; and
a plugin to said Elasticsearch engine to identify a vector query uploaded to said Elasticsearch engine by a user, to divert said vector query to said APU for processing and to return a set of results to said user for said similarity search, each result having an index and ordinal scale representing its distance from said vector query.

2. The system according to claim 1, wherein said plugin comprises:
a query receiver and identifier to receive said vector query and to determine if it is to be diverted to said APU;
a load service to load at least one dataset to said APU for said vector query;
a pre-search filterer to search said at least one dataset for meta data that match said vector query and to filter out non matched data vectors;
a query diverter to divert matched data vectors to said APU; and
a result handler to return said set of results to said user.

3. The system according to claim 2 and further comprising a batch processor to simultaneously process multiple vector queries.

4. The system according to claim 1 wherein said plugin retrieves a vector query as at least one of: a FP32 format and an Int2vector.

5. The system according to claim 2 wherein said query receiver and identifier utilizes Hamming Search and Cosine Re-rank algorithms.

6. The system according to claim 2 wherein said at least one dataset is loaded by an external user web application to said system.

7. A method for an improved similarity search for an Elasticsearch engine, the method comprising:
processing using an accelerated processing unit (APU) a vector query for a similarity search using cosine similarity;
identifying a vector query uploaded to said Elasticsearch engine by a user;
diverting said vector query to said APU for said processing; and
returning a set of results to said user for said similarity search, each result having an index and ordinal scale representing its distance from said vector query.

8. The method according to claim 7, wherein said identifying, diverting and returning comprises:
receiving said vector query and determining if it is to be diverted to said APU;
loading at least one dataset to said APU for said vector query;
searching said at least one dataset for meta data that match said vector query and filtering out non matched data vectors;
diverting matched data vectors to said APU; and
returning said set of results to said user.

9. The method according to claim 8 and further comprising simultaneously processing multiple vector queries.

10. The method according to claim 7 wherein said identifying retrieves a vector query as at least one of: a FP32 format and an Int2vector.

11. The method according to claim 8 wherein said determining if it is to be diverted utilizes Hamming Search and Cosine Re-rank algorithms.

12. The method according to claim 8 wherein said at least one dataset is loaded by an external user web application.

13. A plugin for an Elasticsearch engine; the plugin comprising:
a query receiver and identifier to identify a vector query for a similarity search uploaded by a user and to determine that it is to be diverted to a dedicated accelerated processing unit (APU);
a load service to load at least one dataset to said APU for said vector query;
a pre-search filterer to search said at least one dataset for meta data that matches said vector query and to filter out non matched data vectors;
a query diverter to divert matched data vectors to said APU; and
a result handler to return a set of results to said user for said similarity search, each result having an index and ordinal scale representing its distance from said vector query.

14. The plugin according to claim 13 and further comprising a batch processor to simultaneously process multiple vector queries.

15. The plugin according to claim 13 wherein said plugin retrieves a vector query as at least one of: a FP32 format and an Int2vector.

16. The plugin according to claim 13 wherein said query receiver and identifier utilizes Hamming Search and Cosine Re-rank algorithms.

17. The plugin according to claim 13 wherein said at least one dataset is loaded by an external user web application.

18. A method for an Elasticsearch engine; the method comprising:
identifying a vector query for a similarity search uploaded by a user and determining that it is to be diverted to a dedicated accelerated processing unit (APU);
loading at least one dataset to said APU for said vector query;
searching said at least one dataset for meta data that matches said vector query and filtering out non matched data vectors;
diverting matched data vectors to said APU; and
returning a set of results to said user for said similarity search, each result having an index and ordinal scale representing its distance from said vector query.

19. The method according to claim 18 and further comprising simultaneously processing multiple vector queries.

20. The method according to claim 18 wherein said identifying retrieves a vector query as at least one of: a FP32 format and an Int2vector.

21. The method according to claim 18 wherein said identifying and said determining utilize Hamming Search and Cosine Re-rank algorithms.

22. The method according to claim 18 wherein said at least one dataset is loaded by an external user web application.
